(19) United States
(12) Patent Application Publication
(10) Pub. No.: US 2026/0049562 A1
(43) Pub. Date: Feb. 19, 2026

(54) POSITIONING OF A TURBOMACHINE AIR INTAKE PORT

(71) Applicants: SAFRAN, Paris (FR); SAFRAN AIRCRAFT ENGINES, Paris (FR)

(72) Inventors: Baptiste Jean-Marie RENAULT, Moissy-Cramayel (FR); Michel Pascal ROTTA, Moissy-Cramayel (FR); Nawal JALJAL, Moissy-Cramayel (FR)

(73) Assignees: SAFRAN, Paris (FR); SAFRAN AIRCRAFT ENGINES, Paris (FR)

(21) Appl. No.: 19/103,645

(22) PCT Filed: Aug. 11, 2023
(86) PCT No.: PCT/FR2023/051264

§ 371 Date: Feb. 13, 2025

(30) Foreign Application Priority Data
Aug. 16, 2022 (FR) FR2208326

(51) Int. Cl. F01D 21/00

(52) U.S. Cl. CPC F01D 21/003; F05D 2260/80

(57) ABSTRACT

A turbomachine assembly includes a high-pressure compressor driven by a high-pressure shaft, a low-pressure compressor driven by a low-pressure shaft, the low-pressure shaft being driven at a lower speed than the high-pressure shaft, a first power converter driven by the high-pressure shaft, an air circulation system including a first air bleed port positioned in the high-pressure compressor and a second air bleed port placed upstream of the first air bleed port, a device that determines an operating condition of the turbomachine assembly, and a controller that sends transfer instructions to the first power converter for transferring a power from the high-pressure shaft to the low-pressure shaft or a power from the low-pressure shaft to the high-pressure shaft depending on the operating condition.

### FIELD OF THE INVENTION

The present application generally concerns the field of turbomachines, and more particularly the sizing of the air bleed from a high-pressure compressor.

### STATE OF THE ART

A turbomachine has a main direction extending along a longitudinal axis, and typically includes, from upstream to downstream in the flow direction of the gases, a fan and a primary body including a compression section that may comprise a low-pressure compressor, a high-pressure compressor, a combustion chamber, and a turbine section that may comprise a high-pressure turbine and a low-pressure turbine. The turbomachine may include two intake ports, a high-pressure intake port placed in the vicinity of the outlet of the high-pressure compressor and an intermediate intake port placed upstream. The two compressors can bilaterally transfer part of their mechanical power via electromechanical converters directly mounted on each shaft secured to the high-pressure and low-pressure compressors. This is called hybrid architecture. Reference may be made to document WO 2020/245516 for information on this type of architecture.

Reducing the aircraft fuel consumption involves in particular improving the performances in terms of air bleed needed to pressurize the cabin during all phases of flight.

These performances are intrinsically related to the position of the bleed ports in the turbomachine. The turbomachine can thus comprise two ports at the level of the compressor. When the pressure at the level of the most upstream port is too low, the air is bled at the level of the port located at the outlet of the compressor. However, if the pressure taken is too high during a given flight phase, the efficiency of the corresponding compressor is intrinsically reduced. In addition, using air with a too high pressure involves oversizing the air cooling system, which involves additional costs in terms of consumption and equipment.

### DISCLOSURE OF THE INVENTION

One aim of the invention is therefore to overcome the problems of overpressure of the air bled at the level of the low-pressure compressor for the operation of the aircraft during the different phases of flight while maintaining the air pressure above a critical tipping point on a high-pressure intake port.

To this end, a turbomachine assembly is proposed comprising:
a high-pressure compressor configured to be driven by a high-pressure shaft;
a low-pressure compressor configured to be driven by a low-pressure shaft, the low-pressure shaft being configured to be driven at a lower speed than the high-pressure shaft;
a first power converter configured to be driven by the high-pressure shaft;
an air circulation system comprising a first air bleed port positioned in the high-pressure compressor and a second air bleed port placed upstream of the first air bleed port;
means for determining an operating condition of the turbomachine assembly; and
a controller configured to send transfer instructions to the first power converter for transferring a power from the high-pressure shaft to the low-pressure shaft or a power from the low-pressure shaft to the high-pressure shaft depending on the operating condition.

It may be provided that the means for determining the operating condition comprise at least one of the following elements:
a pressure sensor positioned at the level of the second air bleed port;
a calculator configured to estimate a pressure at the level of the second air bleed port.

It may be provided that the first power converter is an electromechanical converter operating in generator mode, the first power converter being able to take the power from the high-pressure shaft or to transfer the power to the high-pressure shaft.

It may be provided that the assembly further comprises a second power converter receiving the power from the first power converter, the second power converter being able to take the power from the low-pressure shaft or to transfer the power to the low-pressure shaft.

It may be provided that the second power converter is an electromechanical converter operating in motor mode.

It may be provided that the second air bleed port is positioned in the high-pressure compressor.

It may be provided that the high-pressure compressor comprises a given number of compression stages, the second port being positioned between the second stage and the fourth stage, preferably between the second stage and the third stage.

A turbomachine comprising the assembly as described above is also provided according to the invention.

A method for monitoring the turbomachine assembly as described above is also provided according to the invention, comprising the following steps:
determining an operating condition of the turbomachine assembly; and
transferring a power from the high-pressure shaft to the low-pressure shaft or a power from the low-pressure shaft to the high-pressure shaft depending on the operating condition so as to increase a pressure at the level of the second bleed port.

A method for sizing the turbomachine assembly as described above is also provided according to the invention, comprising the following steps:
determining a target pressure in the cruise phase of the turbomachine; and
positioning the second bleed port so that the pressure at the level of the second bleed port is equal to the target pressure.

### DESCRIPTION OF THE FIGURES

Other characteristics, aims and advantages of the invention will emerge from the following description, which is purely illustrative and non-limiting, and which should be read in relation to the appended drawings in which:

FIG. 1 schematically illustrates a half-section of one example of an aircraft turbomachine in accordance with one embodiment of the invention;

FIG. 2a is a simplified view of one example of a conventional turbomachine;

FIG. 2b is a simplified view of another example of an aircraft turbomachine in accordance with one embodiment of the invention;

FIG. 3a is a graph representing the evolution of the pressure in the compressor of FIG. 2b (in broken lines) and of the compressor of FIG. 2a (in solid lines) as a function of the position of the upstream air bleed port at takeoff and during climb;

FIG. 3b is a graph representing the evolution of the pressure in the compressor of FIG. 2b (in broken lines) and in the compressor of FIG. 2a (in solid lines) as a function of the position of the upstream air bleed port in the cruise phase;

FIG. 4 partially illustrates an information and power chain in which the steps of one mode of implementation of the monitoring method of the invention are detailed; and

FIG. 5 is an algorithm diagram illustrating one mode of implementation of the sizing method of the invention.

In all the figures, similar elements bear identical references.

### DETAILED DESCRIPTION OF THE INVENTION

A turbomachine 1 has a main direction extending along a longitudinal axis X, and typically includes, from upstream to downstream in the flow direction of the gases, a fan 2, a primary body including a compression section that may comprise a low-pressure compressor 4 and a high-pressure compressor 5, a combustion chamber 6, and a turbine section that may comprise a high-pressure turbine 7 and a low-pressure turbine 8. In one embodiment, the fan 2 may be ducted and housed in a retention casing and comprises a nacelle 10 defining an aerodynamic envelope of the engine 1. As a variant, the fan may be unducted. The air stream entering the turbomachine 1 is divided into a primary stream configured to pass through the primary body and a secondary stream that bypasses the primary body and is compressed by the fan 2.

Furthermore, the turbomachine 1 may be ducted and comprise more than two bodies.

The turbomachine 1 comprises at least two drive shafts, typically a high-pressure shaft 12 and a low-pressure shaft 11.

The high-pressure shaft 12 is connected to the high-pressure turbine 7 and is configured to drive the high-pressure compressor 5.

The low-pressure shaft 11 is connected to the low-pressure turbine 8 and is configured to drive the low-pressure compressor 4.

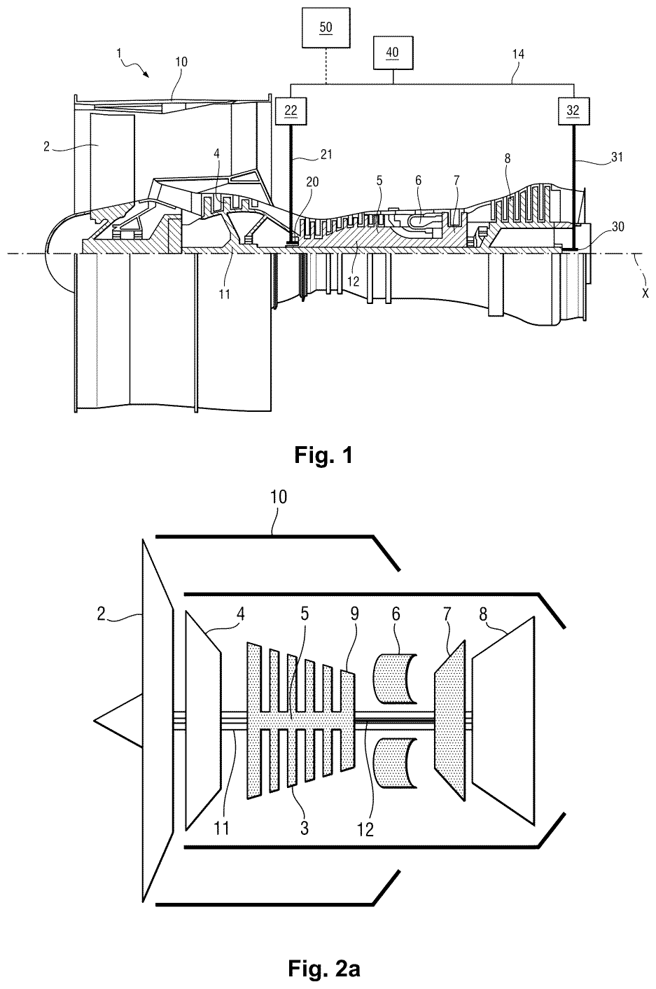

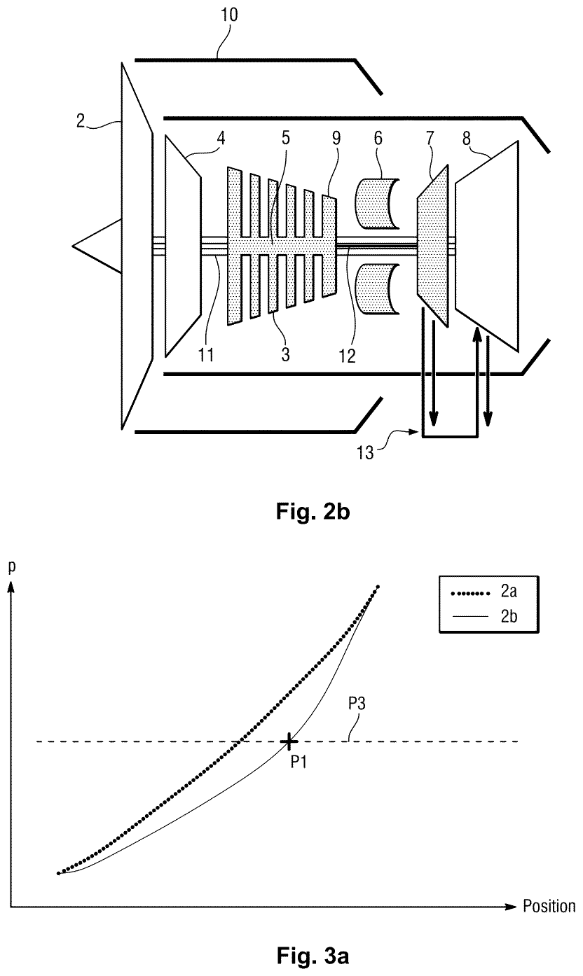

In the case of a two-spool turbomachine, the fan 2 is driven by the low-pressure shaft 11, either directly (as illustrated for example in FIGS. 2a and 2b) by the low-pressure turbine, or via a reduction mechanism that may comprise an epicyclic reduction gear of the planetary or star-like type (see FIG. 1).

In the case of a triple-spool turbomachine, the fan 2 is driven by a third shaft connected to an intermediate turbine extending between the high-pressure turbine 7 and the low-pressure turbine 8. The low-pressure turbine 8 then only drives the low-pressure compressor 4, directly or via a reduction mechanism.

In the present application, the upstream and the downstream are defined relative to the normal flow direction of the gas in the turbomachine 1. Thus, the axis X of the turbomachine 1 corresponds to the axis of rotation of its rotor portions.

The turbomachine 1 also comprises:
a first power converter 21, or HP converter 21, configured to be driven by the high-pressure shaft 12;
an air circulation system comprising two upstream 3 and downstream 9 bleed ports; and
means for determining an operating condition 50 of the turbomachine 1 and a controller 40 configured to send transfer instructions to the first power converter 21 for transferring a power from the high-pressure shaft 12 to the low-pressure shaft 11 or a power from the low-pressure shaft 11 to the high-pressure shaft 12 depending on the operating condition.

The downstream port 9 is positioned in the high-pressure compressor 5. The upstream port 3 is placed upstream of the downstream port 9. In one embodiment, the upstream port 3 is also positioned in the high-pressure compressor 5.

The pressure of the air bled by each port 3, 9 depends on the position of the port in the high-pressure compressor 5. The further upstream the port, the lower the pressure taken.

The air bled by each port 3, 9 passes through an expansion member making it possible to adapt the pressure and the temperature for different applications such as air conditioning for an aircraft cabin or de-icing of the wings of an aircraft.

The turbomachine 1 comprises a first electromechanical converter 21 mechanically connected to the high-pressure shaft 12 via an accessory gearbox 20 and a second electromechanical converter 31 connected mechanically to the low-pressure shaft 11 via a coupling device 30 and electrically to the first converter 21 via an internal electrical network 14. Depending on the operating condition of the turbomachine 1, the first converter 21 is configured to take a power from the high-pressure shaft 12 and to transfer this power to a part of the turbomachine 1, for example to the low-pressure shaft 11 and the second electromechanical converter 31 configured to be driven by the low-pressure shaft 11 and to receive the power from the first converter 21. The first converter 21 then operates in generator mode and the second converter 31 then operates in motor mode. As a variant, the second converter 31 may be configured to take a power from the low-pressure shaft 11 and to transfer this power to a part of the turbomachine 1, for example to the high-pressure shaft 12 and the first electromechanical converter 21 may be configured to be driven by the high-pressure shaft 12 and to receive the power from the second converter 31. The second converter 31 then operates in generator mode and the first converter 21 then operates in motor mode. It will be noted that the (motor/generator) operation of the first and second converters 21, 31 depends on the operating condition of the turbomachine 1 (which is defined later in the description).

The first and second converters 21 and 31 are therefore preferably reversible-type rotating electrical machines able to operate in motor mode and in generator mode. In the motor mode, a rotating electrical machine transforms electrical energy taken from the internal electrical network 14 into mechanical energy injected onto the low-pressure shaft 11 or the high-pressure shaft 12. For this purpose, the electrical power module 22, 32 operates in inverter mode to transform a direct voltage of the internal electrical network 14 into polyphase alternating voltage applied onto the phases of the corresponding rotating electrical machine.

In the generator mode, a rotating electrical machine transforms mechanical energy taken from the low-pressure shaft 11 or the high-pressure shaft 12 into electrical energy injected onto the internal electrical network 14 of the turbomachine 1. For this purpose, the electrical power module 22, 32 operates in rectifier mode to transform a polyphase alternating voltage generated by the rotating electrical machine into direct voltage applied onto the internal electrical network 14.

The first and second converters 21 and 31 are preferably permanent magnet synchronous type machines. Alternatively, the first and second converters 21 and 31 may comprise asynchronous type electrical machines or any other type of electrical machine adapted to the application.

In the following, the invention will be mainly described in the operating case where the first converter 21, or HP converter 21, operates in generator mode and the second converter, or LP converter 31, operates in motor mode to simplify the description. As indicated above, the first converter 21 can however operate in motor mode and the second converter 31 can operate in generator mode, depending on the operating condition of the turbomachine 1.

Where appropriate, the coupling device 30 may integrate a mechanical function for uncoupling the LP converter 31, particularly in case of malfunction of this function.

The internal electrical network 14 of the turbomachine 1 is preferably a continuous electrical network.

Electrical power modules 22, 32 can be electrically connected to the LP converter 31 and to the HP converter 21. In this case, the electrical power modules 22, 32 are electrically connected to the internal electrical network 14 of the turbomachine 1.

In the exemplary embodiment illustrated in the figures, the power stream is oriented from the high-pressure shaft 12 to the low-pressure shaft 11. Thus, a mechanical rotational power of the high-pressure shaft 12 is converted by the HP converter 21 into alternating electrical power and then modulated by the electrical power module 22 as a rectifier in order to be transported in the form of direct electrical power to the inverter 32 making it possible to obtain as output an alternating electrical power converted by the LP converter 31 into mechanical rotational power transmitted to the low-pressure shaft 11.

The means for determining the operating condition 50 of the turbomachine 1 can comprise at least one of the following means, configured to measure and/or estimate given parameters:
a pressure sensor positioned at the level of the upstream port 3;
a calculator configured to estimate a pressure at the level of the second air bleed port 3, the calculator being able to implement for example an algorithm or a mapping modeling the turbomachine 1 obtained by ground tests or by calculations.

All or part of the measured and/or estimated parameters thus make it possible to define the operating condition of the aircraft.

The controller 40 is configured to receive as input the measured and/or estimated parameters and send transfer instructions to the HP converter 21 for transferring a power from the high-pressure shaft 12 to the low-pressure shaft 11 according to these parameters. The power level to be taken from the high-pressure shaft 12 is estimated by the controller 40 from the target pressure value to be reached at the level of the upstream port 3. The controller then transmits, as output, a torque setpoint to control the electromechanical converter 21 via the electrical power module 22. The power module can be in a PWM or full wave mode.

### Monitoring Method E0 According to One Mode of Implementation of the Invention

The hybrid architecture with a HP converter 21 and a LP converter 31 allows power transfers that can be exploited in order to increase, depending on the flight phases, the pressure of the air bled at the level of the upstream port 3. Thus, the upstream port 3 is virtually “moved” according to the power transferred to the low-pressure shaft 11. It is therefore possible to adapt the pressure at the level of the upstream port 3 as closely as possible according to the pressure need of the aircraft and/or to place the upstream port 3 in a stage of the high-pressure compressor 5 further upstream than in the conventional turbomachines.

Thus, when the high-pressure compressor 5 comprises between 6 and 12 stages, the upstream port 3 can be positioned between the second stage and the fourth stage of the high-pressure compressor 5, preferably at the second stage or of the third stage of the high-pressure compressor 5. Indeed, when the pressure at the level of the upstream port 3 is too low to ensure sufficient pressurization of the cabin, increasing the rotational speed of the low-pressure shaft 11 thanks to the controller 40 and to the HP converter 21 allows increasing the pressure at the level of the upstream port 3.

It will be noted that each operating condition involves different pressure conditions at the level of the compression assembly. Thus, for the same stage of a compressor 4, 5, the pressure can change at this stage between two flight phases. Therefore, the pressure at the level of the bleed ports 3, 9 is modified, which involves an increase in the consumption of the air regulation equipment.

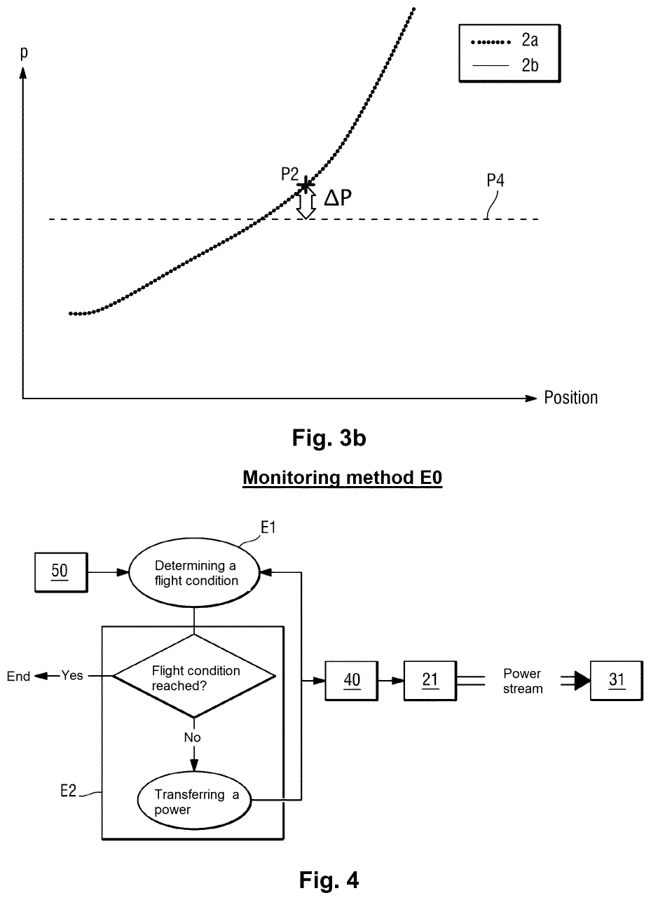

For example, in the configuration of the turbomachine 1 illustrated in FIG. 2a, the upstream port 3 is placed so that the intake pressure is at a value in the vicinity of a target pressure corresponding to the need of the aircraft during the most demanding flight phase, for example the waiting or end-of-cruise phase. In FIG. 3a, this point corresponds to a pressure value P1 located at the limit of the pressure needs represented by a horizontal line at the pressure value P3.

During the cruise flight phase, the operating conditions of the turbomachine change, in particular the pressure at the level of the compression section. The pressure required by the aircraft, represented by the horizontal line at the pressure value P4, is then lower than the effective pressure P2 at the level of the upstream port 3, which is fixed in the high-pressure compressor 5. There is then a pressure deviation ΔP between the pressure point P2 and the pressure need P4, since the pressure taken is too high compared to the required pressure P4. This pressure deviation ΔP however reduces the efficiency of the high-pressure compressor 5 and causes fuel overconsumption.

Using the HP converter 21 allows moving upstream the upstream port 3, so that the pressure point P2 corresponds to the target value P4 in the cruise phase (which generally corresponds to the longest flight phase during a mission), while compensating for the missing pressure during the most demanding flight phase by ensuring a pressure equal to the target value P3 by taking power from the high-pressure shaft 12. The pressure P2 at the level of the upstream port 3 is therefore equal to the pressure P4 required in the cruise phase, it is therefore normally not necessary to take power from the high-pressure shaft 12. On the other hand, during the most demanding flight phase, the power stream 13 transferred from the high-pressure shaft 12 to the low-pressure shaft 11 makes it possible to maintain the operating point at the pressure P3. Indeed, the evolution of the pressure in the case of the architecture of FIG. 2b is identical in FIG. 3a and FIG. 3b.

The method for monitoring the HP converter 21 and the LP converter 31 of the turbomachine 1, illustrated in FIG. 4, has the following steps.

During a step E1, an operating condition of the turbomachine is determined from the data derived from the sensors 50.

During a step E2, the controller 40 compares the operating condition thus determined (for example, the pressure at the level of the upstream port 3) with a predefined operating condition (for example the pressure P3 or P4) and, where appropriate, pilots the HP converter 21 and, optionally, the LP converter 31, so as to transfer a power from the high-pressure shaft 12 to the low-pressure shaft 11 or a power from the low-pressure shaft 11 to the high-pressure shaft 12 depending on the operating condition thus determined. The pressure at the level of the upstream port 3 is then modified.

Steps E1 and E2 are repeated until the determined operating condition matches the predefined operating condition.

The method has the advantage of theoretically saving up to 1% of the fuel carried by the aircraft. By advancing the upstream port 3 by one stage (for example a passage from the fourth to the third stage of a ten-stage high-pressure compressor 5), the fuel saving can reach 0.5%.

### Sizing Method E10 According to One Embodiment of the Invention

There is a position of the upstream port 3 for which, in the cruise phase, the pressure at the level of the upstream port 3 corresponds to the pressure corresponding to the aircraft need P4. This point involves undersizing the upstream port 3 during the other flight phases and using the power transfer between the high-pressure shaft 12 and the low-pressure shaft 11 to maintain the intake pressure to the target pressure value P3.

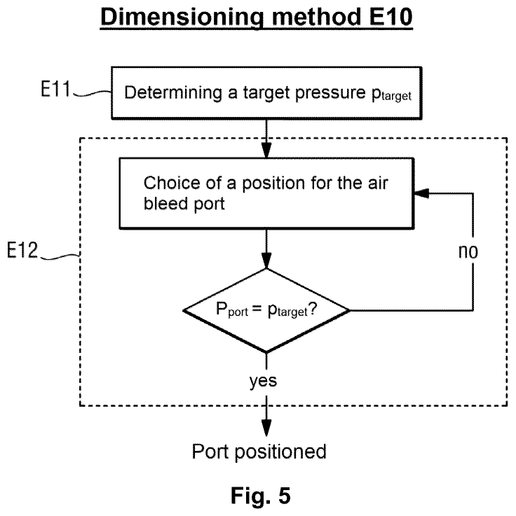

The method for sizing a turbomachine assembly 1 in order to find this position is illustrated by the flowchart in FIG. 5, each of the steps of which is detailed below.

During a step E10, a target pressure P4 is determined in the cruise phase. The target pressure P4 may for example correspond to the pressure need of the aircraft in the cruise phase.

During a step E11, the upstream port 3 is positioned in the compression section, for example in the high-pressure compressor 5, so that the pressure at the level of the upstream port 3 is equal to the target pressure P4 in the cruise phase. The pressure levels at each stage of the high-pressure compressor 5 are mapped accurately, by ground tests or by calculations, in order to evaluate the pressure levels for all the operating conditions of the turbomachine 1.

One example of positioning of the upstream port derived from the sizing method is illustrated in FIG. 3b.

Furthermore, the method above makes it possible to size the upstream port but also the HP converter 21 and the LP converter 31 and the electrical power modules 22, 32, knowing the rotational speed at the take-off and climb ratings of the high-pressure shaft 12 and the low-pressure shaft 11.

1. A turbomachine assembly comprising:
a high-pressure compressor configured to be driven by a high-pressure shaft;
a low-pressure compressor configured to be driven by a low-pressure shaft, the low-pressure shaft being configured to be driven at a lower speed than the high-pressure shaft;
a first power converter configured to be driven by the high-pressure shaft;
an air circulation system comprising a first air bleed port positioned in the high-pressure compressor and a second air bleed port placed upstream of the first air bleed port;
means for determining an operating condition of the turbomachine assembly; and
a controller configured to send transfer instructions to the first power converter for transferring a power from the high-pressure shaft to the low-pressure shaft or a power from the low-pressure shaft to the high-pressure shaft depending on the operating condition.

2. The turbomachine assembly according to claim 1, wherein the means for determining the operating condition comprise at least one of the following elements:
a pressure sensor positioned at a level of the second air bleed port; or
a calculator configured to estimate a pressure at a level of the second air bleed port.

3. The turbomachine assembly according to claim 1, wherein the first power converter is an electromechanical converter operating in generator mode, the first power converter being able to take the power from the high-pressure shaft or to transfer the power to the high-pressure shaft.

4. The turbomachine assembly according to claim 1, further comprising a second power converter receiving the power from the first power converter, the second power converter being able to take the power from the low-pressure shaft or to transfer the power to the low-pressure shaft.

5. The turbomachine assembly according to claim 4, wherein the second power converter is an electromechanical converter operating in motor mode.

6. The turbomachine assembly according to claim 1, wherein the second air bleed port is positioned in the high-pressure compressor.

7. The turbomachine assembly according to claim 1, wherein the high-pressure compressor comprises a given number of compression stages, the second air bleed port being positioned between a second compression stage and a fourth compression stage of the high-pressure compressor.

8. A turbomachine comprising the turbomachine assembly according to claim 1.

9. A method for monitoring the turbomachine assembly according to claim 1, the method comprising:
determining an operating condition of the turbomachine assembly; and
transferring a power from the high-pressure shaft to the low-pressure shaft or a power from the low-pressure shaft to the high-pressure shaft depending on the operating condition so as to increase a pressure at a level of the second bleed port.

10. A method for sizing the turbomachine assembly according to claim 1, the method comprising:
determining a target pressure in a cruise phase of a turbomachine comprising the turbomachine assembly; and
positioning the second air bleed port so that the pressure at the level of the second air bleed port is equal to the target pressure.

11. The turbomachine assembly according to claim 7, wherein the second air bleed port is positioned between the second compression stage and a third compression stage of the high-pressure compressor.
